(19) United States
(12) Patent Application Publication
(10) Pub. No.: US 2014/0080847 A1
(43) Pub. Date: Mar. 20, 2014

(54) Compositions and Methods for Affecting Energy Balance, Body Composition, Fitness, and Well-Being

(71) Applicant: OEJM Products Holdings, LLC, Wilmington, DE (US)

(72) Inventor: Jacobo Edward Geissler, Dallas, TX (US)

(73) Assignee: OEJM Products Holdings, LLC, Wilmington, DE (US)

(21) Appl. No.: 13/801,311

(22) Filed: Mar. 13, 2013

Related U.S. Application Data
(60) Provisional application No. 61/701,179, filed on Sep. 14, 2012.

(51) Int. Cl. A23L 1/30

(52) U.S. Cl. CPC A23L 1/3002
USPC 514/263.34; 514/663

(57) ABSTRACT

The invention discloses compositions, including nutritional products and dietary supplements, comprising 1,4-dimethylpentylamine, which is a compound that occurs naturally in the geranium plant. The invention also describes methods comprising the administration of 1,4-dimethylpentylamine to mammals. The methods result in stimulation of the central nervous system, improved mood, increased vigor, increased lipolysis, increased energy expenditure, enhanced exercise performance, and/or decreased appetite. These effects influence energy balance and can promote weight loss, improve body composition, and/or promote fitness and well-being.

### CROSS-REFERENCE TO RELATED APPLICATIONS

The present application claims the benefit under 35 U.S.C. §119(e) of U.S. Provisional Application No. 61/701,179, filed Sep. 14, 2012, the entirety of which is incorporated herein by reference.

### BACKGROUND OF THE INVENTION

1. Field of the Invention

The field of the invention relates to nutritional products and dietary supplements for affecting energy balance, body composition, fitness, and well-being in mammals.

2. Background

The literature has long documented the health benefits of certain herbs, botanicals, spices, plant extracts, and natural food products. These beneficial health effects are likely due to the variety of active compounds found to naturally occur in these plant materials. Such naturally occurring, active compounds include phthallides, polyacetylenes, phenolic acids, flavonoids, coumarins, capsicinoids, triterpenoids, sterols, monoterpenes, and alkaloids, among others. The compound [6]-gingerol, for example, is a naturally occurring plant phenol and one of the main components of fresh ginger; it exhibits a variety of pharmacological effects, including anti-oxidant and anti-inflammatory activities. See Kim et al., [6]-Gingerol prevents UVB-induced ROS production and COX-2 expression in vitro and in vivo, Free Radic. Res., 41:603-614 (2007).

The plant geranium (Pelargonium graveolens) and its oil contain numerous different compounds, with studies reporting from 15 to over 60 different chemical constituents in geranium plant specimens and oil. See, e.g., Ping et al., A study on the chemical constituents of geranium oil, J. Guizhou Inst. Tech., 25: 82-85 (1996); Jain et al., Essential oil composition of geranium (Pelargonium sp.) from the plains of northern India, Flavour Fragrance J., 16: 44-46 (2001); Virendra et al., Chemical constituents of essential oil of Pelargonium graveolens leaves, Int. J. Aromatherapy, 12: 175-226 (2002); Shellie and Marriott, Comprehensive two-dimensional gas chromatography-mass spectrometry analysis of Pelargonium graveolens essential oil using rapid scanning quadrupole mass spectrometry, Analyst, 128: 879-883 (2003); Jalali-Heravi et al., Characterization of essential oil components of Iranian geranium oil using gas chromatography-mass spectrometry combined with chemometric resolution techniques, J. Chromatography A, 1114: 154-163 (2006); Bouzenna and Krichen, Pelargonium graveolens L'Her. and Artemisia arborescens L. essential oils: Chemical composition, antifungal activity against Rhizoctonia solani and insecticidal activity against Rhysopertha dominica, Nat. Prod. Res., 1-6 (2012). Among the many compounds identified is 1,3-dimethylpentylamine (1,3-DMPA), which is also known as 1,3-dimethylamylamine (1,3-DMAA) or dimethylamylamine (DMAA), methylhexaneamine (MHA), 2-amino-4-methylhexane, 4-methyl-2-hexylamine, and 4-methylhexan-2-amine. One published study has detected this compound in amounts of approximately 13 to over 300 ng/g in geranium plant and oil. See, e.g., Li et al., Identification and quantification of dimethylamylamine in geranium by liquid chromatography tandem mass spectrometry, Anal. Chem. Insights, 7: 1-12 (2012).

While 1,3-DMPA occurs naturally in geranium, it can also be made synthetically. Early studies—studies conducted before naturally occurring 1,3-DMPA from geranium was identified—demonstrated that aliphatic amines, and particularly 1,3-DMPA, exhibit vasopressor or vasoconstriction activity in cats and dogs. See Rohrmann and Shonle, Aminoalkanes as pressor substances, J. Am. Chem. Soc., 66: 1516-1520 (1944); Swanson and Chen, Comparison of pressor action of aliphatic amines, J. Pharmacol. Exp. Ther., 88: 10-13 (1946); Marsh et al., The comparative pharmacology of the isomeric nitrogen methyl substituted heptylamines, J. Pharmacol. Exp. Ther., 103: 325-329 (1951). Administration of 1,3-DMPA in humans also influenced the pressor response, showing the compound exhibits sympathomimetic action in humans as well. Marsh et al. (1951).

Because of the compound's pressor activity, Eli Lilly & Co. marketed 1,3-DMPA as a nasal decongestant and inhalant called Forthane™. The compound 1,3-DMPA was characterized as a more effective vasoconstrictor compared to other compounds available at the time and as having the distinct advantage of a negligible effect on the nervous system. See U.S. Pat. No. 2,350,318. Much more recently, Bloomer et al. have demonstrated that acute oral administration of 1,3-DMPA in humans can result in vasopressor effects similar to the effects of caffeine. Bloomer et al., Effects of 1,3-dimethylamylamine and caffeine alone or in combination on heart rate and blood pressure in healthy men and women, Phys. Sportsmed., 39: 111-120 (2011); Bloomer et al., Effect of caffeine and 1,3-dimethylamylamine on exercise performance and blood markers of lipolysis and oxidative stress in trained men and women, J. Caffeine Res., 1: 169-177 (2011).

The compound 1,3-DMPA has been described as acting as a norepinephrine reuptake inhibitor and/or norepinephrine releasing agent. Charlier, R., Pharmacology of 2-amino-4-methylhexane, Arch. Int. Pharmacodyn. Ther., 83: 573-584 (1950); Bloomer et al. (2011). With such activity, 1,3-DMPA may increase hormone-mediated lipase activity, resulting in increased hydrolysis of fat or lipolysis. See Bloomer et al. (2011); Morimoto et al., Relationship between lipolysis induced by various lipolytic agents and hormone-sensitive lipase in rat fat cells, J. Lipid Res. 42:120-127 (2001). The two Bloomer et al. studies on 1,3-DMPA, however, report results conflicting with this hypothesized mechanism. One of the studies measured the effect of 1,3-DMPA on glycerol and free fatty acid concentration following exercise and found that the compound resulted in increased levels of these markers of lipolysis. Yet in the other concurrent study, 1,3-DMPA was found to have no effect on norepinephrine levels. This other study reported that, while 1,3-DMPA administration could increase blood pressure to a modest degree (i.e., to a degree similar to the degree observed from caffeine ingestion, see, e.g., Robertson et al., Effects of caffeine on plasma renin activity, catecholamines and blood pressure, NEJM 298:181-186 (1978) and Nurminen et al., Coffee, caffeine and blood pressure: a critical review, Eur. J. Clin. Nutr. 53: 831-839 (1999)), it had no effect on heart rate or on circulating catecholamines (norepinephrine and epinephrine).

Other studies have examined the effects of dietary supplements containing 1,3-DMPA on blood pressure, heart rate, lipolysis, and weight loss. These studies show that administration of the supplements can increase lipolysis and decrease appetite, but that administration can also result in acute pressor effects that are similar to the effects of caffeine. McCarthy et al., Biochemical and anthropometric effects of a weight loss dietary supplement in healthy men and women, Nutrition Metabolic Insights, 5: 13-22 (2012); McCarthy et al., A finished dietary supplement stimulates lipolysis and metabolic rate in young men and women, Nutrition Metabolic Insights, 5: 23-31 (2012); Farney et al., Hemodynamic and hematologic profile of healthy adults ingesting dietary supplements containing 1,3-dimethylamylamine and caffeine, Nutrition Metabolic Insights, 5: 1-12 (2012). The compound 1,3-DMPA was one of six dietary ingredients contained within the dietary supplements tested; the supplements included ingredients such as caffeine, which has been shown to stimulate lipolysis and energy expenditure. See Acheson et al., Metabolic effects of caffeine in humans: lipid oxidation or futile cycling?, Am. J. Clin. Nutr., 79: 40-46 (2004). The studies did not examine the lipolysis activity or pressor effect of each individual component of the supplements. See also Whitehead et al., Impact of a dietary supplement containing 1,3-dimethylamylamine on blood pressure and bloodborne markers of health: a 10-week study, Nutrition Metabolic Insights, 5: 33-39 (2012).

While users of dietary supplements containing 1,3-DMPA report positive effects, it is desirable to find a dietary supplement able to provide similar or improved benefits and activity profiles. Athletes, fitness professionals, and any individual seeking to improve his or her health, fitness or well-being would benefit from a dietary supplement that is able to promote fitness and weight loss with a reduced pressor effect.

### BRIEF SUMMARY OF THE INVENTION

The present invention relates to the unexpected and advantageous activity profile of 1,4-dimethylpentylamine (e.g., as an isolated, purified, extracted, and/or synthesized compound). The compound 1,4-dimethylpentylamine (also called 1,4-DMPA) is a naturally occurring compound that exhibits a unique and desirable activity profile when administered to mammals. In particular, administration of 1,4-DMPA is effective to increase CNS (central nervous system) stimulation, decrease fatigue, improve mood, increase lipolysis, increase energy expenditure, and/or decrease or suppress appetite. Furthermore, such administration of 1,4-DMPA exhibits comparatively low pressor activity. For example, the pressor effect resulting from administration of 1,4-DMPA is lessened or reduced when compared to the pressor effect resulting from administration of the compound 1,3-DMPA.

Accordingly, certain aspects of the present invention relate to compositions comprising 1,4-dimethylpentylamine or 1,4-DMPA. In some aspects, the compositions comprise 1,4-DMPA in combination with a substance selected from the group consisting of caffeine (1,3,7-trimethylxanthine), theophylline, paraxanthine, phenethylamine, arginine α-ketoglutarate, rauwolscine, higenamine (also known as norcoclaurine), citicoline, yohimbine, tyrosine, n-acetyl-1-tyrosine, creatine, β-alanine, caffeic acid, and a plant extract. In certain embodiments, the plant extract is selected from the group consisting of bauhinia purpurea L., bacopa monnieri, schisandra chinensis, hemerocallis fulva, cirsium oligophyllum, and yohimbe (pausinystalia johimbe). Other embodiments of the invention relate to compositions comprising 1,4-DMPA and an extract selected from the group consisting of bauhinia purpurea L., bacopa monnieri, cirsium oligophyllum, and yohimbe (pausinystalia johimbe). In addition, certain embodiments of the present invention relate to compositions comprising 1,4-DMPA, arginine α-ketoglutarate, creatine, β-alanine, schisandra chinensis extract, and caffeine. In other embodiments, the present invention relates to compositions comprising 1,4-DMPA, arginine α-ketoglutarate, creatine, β-alanine, and schisandra chinensis extract. In some embodiments, the compositions comprise 1,4-DMPA and one or more other substances selected from the group consisting of caffeine, bauhinia purpurea L. extract, hemerocallis fulva extract, yohimbe (pausinystalia johimbe) extract, and higenamine. In further embodiments, the invention relates to compositions comprising 1,4-DMPA, bauhinia purpurea L. extract, hemerocallis fulva extract, yohimbe (pausinystalia johimbe) extract, and higenamine. In additional embodiments, the compositions of the present invention comprise 1,4-DMPA and caffeine. Accordingly, certain embodiments relate to compositions comprising 1,4-DMPA, caffeine, bauhinia purpurea L. extract, hemerocallis fulva extract, yohimbe, (pausinystalia johimbe) extract, and higenamine. The present invention also relates to embodiments wherein the compositions do not contain caffeine or are substantially free from caffeine. Other embodiments of the present invention relate to compositions comprising 1,4-DMPA and one or more substances selected from the group consisting of caffeine, arginine α-ketoglutarate, rauwolscine, higenamine, yohimbine, creatine, β-alanine, bauhinia purpurea L. extract, bacopa monnieri extract, schisandra chinensis extract, hemerocallis fulva extract, yohimbe (pausinystalia johimbe) extract, and cirsium oligophyllum extract.

The present invention additionally relates to compositions comprising 1,4-DMPA, wherein the 1,4-DMPA is selected from the group consisting of (R)-1,4-DMPA; (S)-1,4-DMPA; a racemic mixture of (R)-1,4-DMPA and (S)-1,4-DMPA; a mixture of (R)-1,4-DMPA and (S)-1,4-DMPA, wherein the mixture is enriched for (R)-1,4-DMPA; and a mixture of (R)-1,4-DMPA and (S)-1,4-DMPA, wherein the mixture is enriched for (S)-1,4-DMPA. In further embodiments, the 1,4-DMPA is (R)-1,4-DMPA or a mixture enriched for (R)-1,4-DMPA. In particular embodiments, the present invention relates to compositions comprising 1,4-DMPA, wherein the 1,4-DMPA is a salt selected from the group consisting of 1,4-DMPA tartrate and 1,4-DMPA HCl.

Additional embodiments of the present invention relate to compositions comprising 1,4-DMPA, wherein the composition is formulated for oral administration or is orally ingestible. In certain embodiments, the composition is an oral dosage form. In further embodiments, the oral dosage form is selected from the group consisting of tablet, capsule, gel cap, powder, gum, gel (including, e.g., paste), and solution. The present invention also relates to compositions comprising 1,4-DMPA that are nutritional products or dietary supplements. In any of these embodiments, the orally ingestible composition may comprise 1,4-DMPA selected from the group consisting of (R)-1,4-DMPA; (S)-1,4-DMPA; a racemic mixture of (R)-1,4-DMPA and (S)-1,4-DMPA; a mixture of (R)-1,4-DMPA and (S)-1,4-DMPA, wherein the mixture is enriched for (R)-1,4-DMPA; and a mixture of (R)-1,4-DMPA and (S)-1,4-DMPA, wherein the mixture is enriched for (S)-1,4-DMPA.

The present invention also relates to compositions comprising 1,4-DMPA in specific amounts or concentrations. In certain embodiments, the 1,4-DMPA is present in amount ranging from about 5 mg to about 200 mg. In further embodiments, the amount of 1,4-DMPA ranges from about 10 mg to about 100 mg. In other embodiments, the 1,4-DMPA is present in an amount of about 20-70 mg, and in one embodiment, the 1,4-DMPA is present in an amount of about 30 mg.

Furthermore, the present invention relates to methods comprising the administration of 1,4-DMPA. Certain aspects relate to methods for affecting energy balance in a mammal (e.g., a human), comprising administering an amount of 1,4-DMPA, wherein the amount results in an effect selected from the group consisting of (a) increased stimulation of the central nervous system; (b) increased vigor (e.g., increased energy level); (c) increased lipolysis; (d) increased energy expenditure; and (e) suppressed appetite. Accordingly, certain embodiments of the present invention relate to a method for affecting energy balance in a mammal (e.g., a human), comprising administering an amount of 1,4-DMPA effective to increase stimulation of the central nervous system. In further embodiments, the amount of 1,4-DMPA is also effective to increase focus of the mammal; decrease sense of fatigue of the mammal; improve mood of the mammal; increase vigor of the mammal; increase lipolysis in the mammal; increase energy expenditure of the mammal; increase physical endurance of the mammal; increase strength output of the mammal; and/or suppress or reduce appetite of the mammal.

In certain embodiments, the methods of the present invention result in increased energy output of a mammal over a unit of time, wherein the unit of time ranges from about 3 hours to about 24 hours. In other embodiments, the methods of the present invention result in decreased energy input of a mammal over a unit of time, wherein the unit of time ranges from about 3 hours to about 24 hours. Accordingly, certain embodiments of the present invention concern methods that result in an energy deficit in a mammal over a unit of time, wherein the unit of time ranges from about 3 hours to about 24 hours.

The present invention also relates to methods for stimulating the central nervous system in a mammal, comprising administering an effective amount of 1,4-DMPA. In certain aspects, the methods further comprise increasing focus of the mammal; decreasing sense of fatigue of the mammal; improving mood of the mammal; increasing vigor of the mammal; increasing lipolysis in the mammal; increasing energy expenditure of the mammal; increasing physical endurance of the mammal; increasing strength output of the mammal; and/or reducing or suppressing appetite of the mammal. In certain embodiments, the mammal is a human. Accordingly, the present invention further relates to methods for stimulating the central nervous system in a human, comprising administering an effective amount of 1,4-DMPA. In additional aspects, the methods further comprise increasing focus of the human; decreasing sense of fatigue of the human; improving mood of the human; increasing vigor of the human; increasing lipolysis in the human; increasing energy expenditure of the human; increasing physical endurance of the human; increasing strength output of the human; and/or reducing or suppressing appetite of the human.

Other aspects of the present invention relate to methods for increasing lipolysis in a human, comprising administering an effective amount of 1,4-DMPA. In addition, the present invention relates to methods for increasing energy expenditure of a human, comprising administering an effective amount of 1,4-DMPA. Further aspects of the present invention relate to methods for suppressing appetite of a human, comprising administering an effective amount of 1,4-DMPA. Certain embodiments of the present invention relate to methods for improving mood of a human, comprising administering an effective amount of 1,4-DMPA. In addition, the present invention relates to methods for increasing vigor of a human, comprising administering an effective amount of 1,4-DMPA. Thus, certain embodiments of the invention relate to a method of administering a food or dietary supplement comprising administering an amount of 1,4-dimethylpentylamine to a human, wherein the administering step results in one or more effects in the human selected from the group consisting of (a) increased stimulation of the central nervous system; (b) increased vigor; (c) improved mood; (d) increased focus; (e) decreased sense of fatigue; (f) increased lipolysis; (g) increased energy expenditure; and (h) suppressed appetite. In some embodiments, the administering step is also effective to increase physical endurance of the human. In additional or alternative embodiments, the administering step is also effective to increase strength output of the human.

The methods of the present invention additionally relate to embodiments comprising administration of 1,4-DMPA, wherein the administration is self-administration. Accordingly, certain embodiments of the present invention relate to methods comprising administering 1,4-DMPA, wherein the administering step is carried out by self-administering. Administration includes but is not limited to oral administration. Therefore, in some embodiments, the 1,4-DMPA is administered in the form of a food or dietary supplement. In further embodiments, the food or dietary supplement comprises a substance selected from the group consisting of caffeine, theophylline, paraxanthine, phenethylamine, arginine α-ketoglutarate, rauwolscine, yohimbine, tyrosine, n-acetyl-1-tyrosine, creatine, β-alanine, caffeic acid, higenamine, citicoline, and a plant extract, wherein the plant extract is selected from the group consisting of bauhinia purpurea L., bacopa monnieri, schisandra chinensis, hemerocallis fulva, yohimbe (pausinystalia johimbe), and cirsium oligophyllum.

The present invention also relates to methods comprising administering 1,4-DMPA, wherein the administering is repeated. In certain embodiments, the administering is repeated within a 24-hour time period. Alternatively, in certain embodiments, the methods of the present invention comprise administering 1,4-DMPA, wherein the administering comprises two administrations per day. In further embodiments, the amount of 1,4-DMPA administered does not exceed 300 mg per day. Other embodiments of the present invention relate to methods comprising administering 1,4-DMPA, wherein the administering is repeated daily for at least two consecutive or non-consecutive days. The present invention also relates to methods wherein the method or the administering is repeated daily (or about daily) over a time course ranging from about seven days to about six months.

The present invention additionally relates to methods comprising administering an amount of 1,4-DMPA, wherein the amount of 1,4-DMPA is a daily dose ranging from about 5 mg to about 200 mg. In certain embodiments, the daily dose ranges from about 20 mg to about 70 mg. In further embodiments, the daily dose is about 30 mg. In some aspects of the present invention, the daily dose is gradually increased from an initial daily dose up to a final daily dose. In additional embodiments, the daily dose is increased by an amount ranging from about 5 mg to about 25 mg on a weekly, bi-monthly, or monthly basis. In other embodiments, the daily dose is expressed as mg per kg, and the amount of 1,4-DMPA is a daily dose ranging from about 0.25 mg/kg to about 5 mg/kg. In certain embodiments, the daily dose ranges from about 0.5 mg/kg to about 2 mg/kg. In further embodiments, the daily dose is about 0.5 mg/kg, 0.75 mg/kg, 1 mg/kg, 1.5 mg/kg, or 2 mg/kg. In embodiments where the daily dose is gradually increased, for certain of these embodiments the daily dose is increased by an amount ranging from about 0.1 mg/kg to about 1 mg/kg (e.g., by about 0.2 mg/kg, by about 0.3 mg/kg, etc.) on a weekly, bi-monthly, or monthly basis.

The present invention also relates to methods for affecting body composition. Accordingly, certain aspects of the present invention relate to methods comprising administering 1,4-DMPA to a mammal or a human, wherein the administering is repeated and results in decreased percentage of fat mass. In some embodiments, the methods result in increased percentage of muscle mass. In further embodiments, the methods result in decreased percentage of fat mass and increased percentage of muscle mass in the mammal, which in some embodiments is a human.

The present invention further relates to methods comprising administering an amount of 1,4-DMPA that exhibits a reduced or lessened pressor effect when compared to a pressor effect exhibited by a substantially equivalent amount of 1,3-DMPA. Accordingly, certain aspects of the present invention relate to methods comprising administering an amount of 1,4-DMPA, wherein the amount of 1,4-DMPA exhibits a 1,4-DMPA pressor effect, and wherein the 1,4-DMPA pressor effect is less than a 1,3-DMPA pressor effect resulting from administering an amount of 1,3-DMPA that is substantially equivalent to the amount of 1,4-DMPA. In certain embodiments, the present invention relates to methods comprising administering an amount of 1,4-DMPA effective to affect energy balance, increase CNS stimulation, decrease sense of fatigue/exertion, improve mood, increase vigor, increase lipolysis, increase energy expenditure, and/or decrease appetite, wherein the administering results in a 1,4-DMPA pressor effect, wherein the 1,4-DMPA pressor effect is less than a 1,3-DMPA pressor effect resulting from administering an amount of 1,3-DMPA that is substantially equivalent to the amount of 1,4-DMPA. In some embodiments, the 1,4-DMPA pressor effect and the 1,3-DMPA pressor effect are together selected from the group consisting of (a) an effect on heart rate, (b) an effect on systolic blood pressure, (c) an effect on diastolic blood pressure, and (d) an effect on rate pressure product. In certain embodiments, the 1,4-DMPA pressor effect is about 10% to about 70% less than the 1,3-DMPA pressor effect. In further embodiments, the 1,4-DMPA pressor effect is about 20% to about 50% less than the 1,3-DMPA pressor effect. The present invention additionally relates to embodiments wherein the 1,4-DMPA pressor effect and the 1,3-DMPA pressor effect are both an effect on systolic blood pressure, and wherein the 1,4-DMPA pressor effect is about 10% to about 50% less than the 1,3-DMPA pressor effect. In certain embodiments, the 1,4-DMPA is selected from the group consisting of (R)-1,4-DMPA; (S)-1,4-DMPA; a racemic mixture of (R)-1,4-DMPA and (S)-1,4-DMPA; a mixture of (R)-1,4-DMPA and (S)-1,4-DMPA, wherein the mixture is enriched for (R)-1,4-DMPA; and a mixture of (R)-1,4-DMPA and (S)-1,4-DMPA, wherein the mixture is enriched for (S)-1,4-DMPA. In particular embodiments, the 1,4DMPA is (R)-1,4-DMPA or a mixture of (R)-1,4-DMPA and (S)-1,4-DMPA, wherein the mixture is enriched for (R)-1,4-DMPA.

### DETAILED DESCRIPTION OF THE INVENTION

Certain aspects of the present invention relate to compositions, uses, and methods that exploit the unique and unexpected activity profile of 1,4-dimethylpentylamine (1,4-DMPA). The compound 1,4-DMPA, like the compound 1,3-DMPA, occurs naturally in the geranium plant. The compound 1,4-DMPA exhibits desirable activities and effects in mammals such as, e.g., increasing central nervous system stimulation, decreasing the sense of fatigue or exertion, improving mood, increasing vigor, increasing lipolysis, increasing energy expenditure or thermogenesis, improving physical performance, and/or decreasing appetite. At the same time, the compound 1,4-DMPA unexpectedly exhibits reduced or lessened pressor activity compared to 1,3-DMPA, as well as reduced or lessened feelings of anxiety, nervousness, or jitteriness. Accordingly, certain aspects of the present invention relate to nutritional products and food and dietary supplements comprising 1,4-DMPA.

Other aspects of the present invention relate to methods comprising the administration of 1,4-DMPA to mammals. In certain aspects, the methods comprise administering 1,4-DMPA to a mammal in order to affect energy balance. Energy balance refers to energy input relative to energy output, and it may refer to an energy deficit (i.e., a negative energy balance) or to an energy surplus (i.e., a positive energy balance). Energy balance may describe energy input relative to energy output over the course of hours, over the course of a day, or over the course of weeks or months. In humans, for example, energy input/output is commonly expressed as a 24-hour kilocalorie value, and a kilocalorie deficit or surplus is measured by subtracting the total amount of energy or kilocalories expended from the total amount of energy or kilocalories ingested during a given 24-hour time period. Administration of 1,4-dimethylpentylamine affects energy balance by increasing energy output and/or decreasing energy input. Such effect(s) on energy balance can, over time, lead to weight loss. In addition, such effect(s) on energy balance over time can result in a change in body composition, such as an increase in skeletal muscle mass and/or a decrease in fat mass. Increasing energy output and/or decreasing energy input over time can therefore improve the health and fitness of a mammal.

The present invention also relates to methods comprising the administration of an amount of 1,4-dimethylpentylamine effective to stimulate (or to increase the stimulation of) the central nervous system (CNS). By causing CNS stimulation, administration of 1,4-DMPA can increase alertness, produce mild euphoria, and produce a sense of lessened fatigue and exertion. Improved alertness and a reduced sense or feeling of fatigue may in turn increase force or total strength output when performing acute physical activity. Additionally or alternatively, improved alertness and a reduced sense or feeling of fatigue may improve or enhance endurance-type activities. Accordingly, continued use or administration of 1,4-DMPA may lead to improved muscle strength and increased accrual of muscle mass over time.

The present invention further relates to methods comprising the administration of an amount of 1,4-dimethylpentylamine effective to increase lipolysis. Lipolysis is the process by which stored triglycerides within adipocytes or fat cells are liberated and hydrolyzed to form free fatty acids and glycerol. Lipolysis activity can be determined by measuring free fatty acid and/or glycerol concentration in blood plasma. By releasing stored energy and making it available for energy expenditure, lipolysis may improve physical performance, especially in endurance-type events. In addition, continued lipolysis over time is one mechanism by which a reduction in fat mass occurs. A method for stimulating lipolysis can therefore be used to combat obesity and its associated health risks. Certain aspects of the present invention, therefore, relate to methods for increasing lipolysis and/or increasing the amount of energy available for expenditure or output, wherein the methods comprise the administration of an effective amount of 1,4-dimethylpentylamine.

Another aspect of the present invention relates to methods comprising the administration of an amount of 1,4-dimethylpentylamine effective to increase energy expenditure. Energy expenditure or thermogenesis can be assessed by measuring a mammal's level or rate of oxygen consumption and carbon dioxide production (for example, in a respiration chamber). In addition, observing or experiencing an increase in body temperature (e.g., feeling warm or hot) may indicate an increase in thermogenesis. Increasing energy expenditure is another mechanism by which 1,4-DMPA administration affects metabolic rate, energy balance, body composition, and/or fitness.

By stimulating the CNS, increasing lipolysis (and thereby increasing the amount of energy available for expenditure or output), and/or increasing thermogenesis, administration of 1,4-DMPA can enhance exercise or physical performance, including strength output and/or performance of sustained or endurance-type activities. The present invention therefore additionally relates to methods of enhancing physical performance, including methods of improving endurance and methods of increasing strength output. One aspect of the present invention relates to uses and methods for providing energy and strengthening to skeletal muscles, and for facilitating the ability of skeletal muscles to sustain prolonged periods of intense physical activity, wherein the uses and methods comprise administering a composition or dietary supplement comprising 1,4-DMPA. Another aspect of the present invention relates to uses and methods for increasing alertness, focus, and/or energy level, and/or reducing the sense of fatigue, and thereby increasing strength output, wherein the uses and methods comprise administering a composition or dietary supplement comprising 1,4-DMPA. In certain embodiments, the composition or dietary supplement is administered to a mammal (e.g., human, bovine, equine, ovine, hircine, porcine, canine, feline, etc.). In further embodiments, the composition or dietary supplement is administered to a human.

Another aspect of the present invention relates to methods of administering an amount of 1,4-dimethylpentylamine effective to suppress appetite in mammals. Reduced or suppressed appetite may involve a lessened sense of hunger or an increased sense of fullness. It may also involve satiation (a sense of fullness within or during a meal) and/or satiety (a sense of fullness between meals). Accordingly, administration of 1,4-DMPA may reduce within meal hunger and increase within meal fullness, and thereby reduce food intake or eating rate. Additionally or alternatively, administration of 1,4-DMPA may reduce hunger and increase fullness between meals. By reducing or suppressing appetite, administration of 1,4-DMPA can lead to reduced energy input. Furthermore, continuous appetite suppression, or a sustained or prolonged reduction in appetite, may result in reduced lipogenesis or fat formation. Additionally or alternatively, continuous appetite suppression, or a sustained or prolonged reduction in appetite, may result in a reduction in or loss of fat mass.

Appetite suppression may refer to a reduction in appetite as assessed on a day-by-day, week-by-week, or month-by-month basis. Continuous appetite suppression, or a sustained or prolonged reduction in appetite, may refer to a daily reduction in appetite that lasts for at least two consecutive days, and in some embodiments for at least a week. Continuous appetite suppression, or a sustained or prolonged reduction in appetite, may alternatively refer to a general or overall reduction in appetite as assessed on a daily, weekly, or monthly basis.

Other aspects of the present invention relate to methods of administering an amount of 1,4-dimethylpentylamine effective to improve mood, sense of well-being, and/or vigor in a mammal. Thus, certain embodiments of the present invention relate to methods comprising administering to a mammal (such as, e.g., a human) an amount of 1,4-DMPA effective to increase energy level, happiness, liveliness, and/or activeness or desire to engage in activities. In certain aspects, the amount of 1,4-DMPA is effective to reduce feelings of distress and/or sense of tiredness or fatigue in the mammal. Accordingly, certain embodiments of the present invention relate to methods comprising administering to a mammal (such as, e.g., a human) an amount of 1,4-DMPA effective to decrease feelings of anger, sadness, confusion, fatigue, tiredness, sluggishness, tension, nervousness, and/or anxiety.

As used throughout the description, the terms administration, administering, administer, etc. encompass any form of administration, including but not limited to self-administration. Further, compositions comprising 1,4-DMPA, including combinations comprising 1,4-DMPA, may be formulated for oral administration. Accordingly, in certain embodiments of the present invention, 1,4-DMPA is formulated as a solid or liquid oral dosage form, such as, for example, tablet, capsule, gel cap, powder, paste, gel, solution, or other orally ingestible form. In the above and other combinations, administration may involve the administration of a single composition that in turn comprises multiple components or substances, including 1,4-DMPA. Such an example would be a dietary supplement, formulated as an oral dosage form (e.g., tablet, capsule, powder, gel, or solution), that comprises several dietary ingredients and optionally other ingredients (including, e.g., excipients). In addition or alternatively, methods comprising administering 1,4-DMPA may involve concurrent administration of multiple, separate oral dosage forms, or any other combination of administrations and dosage routes.

Additional aspects of the present invention relate to repeat, extended, sustained, or prolonged administration of 1,4-DMPA to a mammal. Such repeat, extended, or prolonged administration may occur over a time period ranging from days to months. In addition, repeat, extended, or prolonged administration may comprise daily (or about daily) administration of 1,4-DMPA, or alternatively may comprise administration of 1,4-DMPA at selected times, such as before engaging in or during physical activity. Repeat, extended, sustained, or prolonged administration of 1,4-DMPA may facilitate a gain in skeletal muscle strength and mass. Additionally or alternatively, repeat, extended, sustained, or prolonged administration of 1,4-DMPA may facilitate a loss of fat mass. Furthermore, repeat, extended, sustained, or prolonged administration of 1,4-DMPA may improve a mammal's mood and sense of well-being. Daily or about daily administration encompasses administrations that are repeated for at least two consecutive or non-consecutive days. In embodiments where administration is repeated for longer durations (e.g., for 7 days), such daily or about daily administration encompasses continuous administration (with no stops and starts) as well as intermittent administration (where administration stops and resumes at either regular or irregular intervals). For example, embodiments of the methods of the present invention relate to administration for one to six days per week, administrations in cycles (e.g., administrations that occur each day for 5 days, followed by 2 days of no administration; or administrations that occur for two to eight consecutive weeks, followed by a rest period of no administration for up to one week), and/or administration on alternate days.

Certain aspects of the present invention, therefore, relate to uses and methods for affecting body composition in a mammal, comprising administering to the mammal a composition or dietary supplement comprising 1,4-DMPA. The present invention also relates to uses and methods for promoting weight loss in a human, comprising administering to the human a composition or dietary supplement comprising 1,4-DMPA. In humans, a change in body composition that includes an increase in muscle mass and/or a decrease in fat mass generally improves an individual's health and fitness, and such a change in body composition is particularly beneficial to individuals for whom weight loss or a reduction in fat mass is necessary to combat health risks associated with obesity. In addition, athletes and fitness professionals will benefit from methods for altering body composition as described herein.

Other aspects of the present invention relate to compositions and methods for affecting energy balance, increasing CNS stimulation, decreasing sense of fatigue, improving mood, increasing vigor, increasing lipolysis, increasing energy expenditure, and/or reducing appetite, wherein the compositions and methods are directed to a naturally occurring compound that exhibits an improved activity profile compared to 1,3-DMPA. For example, the compound 1,4-DMPA is better tolerated than the compound 1,3-DMPA. Thus, the present invention also relates to methods for affecting energy balance, body composition, fitness, and/or sense of well-being comprising the use or administration of a composition or dietary supplement comprising 1,4-DMPA, wherein the composition or supplement is better tolerated compared to a composition or dietary supplement comprising 1,3-DMPA. The methods of the present invention additionally relate to the administration of 1,4-dimethylpentylamine to humans in order to stimulate the CNS, decrease fatigue, improve mood, increase vigor, increase lipolysis, increase energy expenditure, and/or decrease appetite, wherein the methods result in reduced vasopressor effect when compared to similar or analogous methods comprising 1,3-DMPA administration. With reduced vasopressor effects, the methods of the present invention allow for higher tolerated doses and/or longer durations of administration of the compound, or of a dietary supplement comprising it. The methods of the present invention thereby allow an individual to further exploit the positive effects of administering a compound found to occur naturally in geranium-1,4-DMPA.

While both 1,3-DMPA and 1,4-DMPA occur naturally in geranium plant and oil, see Li et al. (2012), the two compounds differ structurally due to the different positions of methyl substitution. The compound 1,3-DMPA contains a methyl group at carbon-3, whereas 1,4-DMPA contains a methyl group at carbon-4. Carbon-1 in both compounds is a chiral or stereogenic center. Substitution at carbon-3 in 1,3-DMPA creates an additional chiral center, generating four different stereoisomers (two enantiomer pairs) for 1,3-DMPA: (1S,3S)/(1R,3R) and (1S,3R)/(1R,3S). Within each enantiomeric pair, the compounds have the same physical and chemical properties and cannot be easily separated (e.g., (1S,3S) is chemically and physically the same as (1R,3R)). The compound 1,4-DMPA, on the other hand, has only the two enantiomers resulting from chirality at carbon-1: (S)-1,4-dimethylpentylamine and (R)-1,4-dimethylpentylamine. Accordingly, one aspect of the present invention relates to the unexpected advantages resulting from the reduced number of chiral centers in 1,4-DMPA compared to 1,3-DMPA and the unexpected activity profiles of each of the 1,4-DMPA enantiomers.

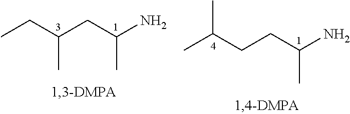

1,4-DMPA is also known as 1,4-dimethylamylamine (1,4-DMAA), 2-amino-5-methylhexane, and 5-methyl-2-hexylamine. It has been detected in amounts of approximately 3 to 220 ng/g in geranium plant and its edible oil. See, e.g., Li et al. (2012). Thus, in certain embodiments, 1,4-DMPA is extracted, isolated, and/or purified from natural sources. In alternative embodiments, 1,4-DMPA is made synthetically.

Early vasopressor animal studies included 1,4-DMPA among the series of aliphatic amines tested. The studies showed that 1,4-DMPA, like 1,3-DMPA, possesses vasopressor activity. The vasopressor effects of the two compounds were measured to be within the same order of magnitude. See Rorhmann and Shonle (1994); Swan and Chen (1946); and Marsh et al. (1951).

Vasopressor effect is a measure of vascular constriction in response to a particular compound. Vasoconstriction, and the consequent increase in blood pressure, result from activation of the sympathetic nervous system, which controls peripheral tissues. The central nervous system (CNS) is distinct from the peripheral tissues, and a compound with a pressor effect will not necessarily have a CNS stimulant effect, improve mood, activate lipolysis, increase energy expenditure, or reduce appetite. For example, the compound tyramine is known to have a pressor effect, yet it does not possess a CNS stimulant effect. Mahon and Mashford, The pressor effect of tyramine in man and its modification by reserpine pretreatment, J. Clin. Invest., 42: 338-345 (1963).

While 1,4-DMPA may exhibit pressor effects, any activity of the compound on CNS stimulation, fatigue, mood, lipolysis, energy expenditure, or appetite suppression was unknown. The present invention demonstrates that 1,4-DMPA exhibits a CNS stimulatory effect, as evidenced by animal studies described herein, which show that oral administration of the compound results in hyperactivity, piloerection, nasal discharge, tremors, tachycardia and tail elevation. See Example 2. In addition, administrations of 1,4-DMPA to human subjects have generated reports of stimulant effects, including increased alertness and focus and decreased fatigue, as well as reports of improved mood and vigor.

The present invention also shows that 1,4-DMPA exhibits unexpected and advantageous properties, including when compared to 1,3-DMPA. For example, the administration of 1,4-DMPA is reported to increase focus and alertness, and to improve mood, without increasing restlessness, anxiety, or jitteriness, the latter of which are effects reported following 1,3-DMPA administration. In addition, administration of 1,4-DMPA, while achieving the desired stimulant and mood effects, exhibits an unexpectedly improved pressor effect profile. In particular, orally administered 1,4-DMPA exhibits less pressor effect when compared to 1,3-DMPA. Because of the compound's comparatively low pressor effect, a user can reap the benefits of 1,4-DMPA use with less concern about an increase—even a modest increase—in blood pressure. The unexpected and improved activity profile of 1,4-DMPA therefore allows methods and uses comprising higher tolerated doses and/or longer durations of treatment when compared to methods and uses involving 1,3-DMPA. Accordingly, certain aspects of the present invention relate to uses and methods exploiting the unique activity profile of 1,4-DMPA.

Certain embodiments of the present invention relate to methods comprising administering 1,4-DMPA to affect energy balance, achieve a CNS stimulant effect, decrease sense of fatigue, improve mood, increase vigor, increase lipolysis, increase energy expenditure or thermogenesis, and/or reduce appetite in mammals, wherein administration of 1,4-DMPA results in a pressor effect that is less than a pressor effect resulting from administration of 1,3-DMPA. In further embodiments, the amount of 1,3-DMPA is substantially equivalent to the amount of 1,4-DMPA. For example, the amount of 1,3-DMPA may be within about ±30%, about ±25%, about ±20%, about ±15%, about ±10%, or about ±5% of the amount of 1,4-DMPA. In other embodiments, the amount of 1,3-DMPA and the amount of 1,4-DMPA are effectively equivalent amounts or doses with respect to one or more of the following effects: CNS stimulation, fatigue reduction, improved mood, increased vigor, lipolysis activity, energy expenditure or thermogenesis, and/or appetite suppression. In certain aspects of the latter embodiments, the amount of 1,4-DMPA and the amount of 1,3-DMPA produce substantially the same effect on CNS stimulation, fatigue, mood, vigor, lipolysis activity, energy expenditure or thermogenesis, and/or appetite. In further aspects, administration of 1,4-DMPA results in a pressor effect that is less than a pressor effect resulting from administration of 1,3-DMPA by about 10-75%. In further embodiments, the amount of 1,4-DMPA administered exhibits a pressor effect that is about 15%, about 20%, about 25%, about 30%, about 40%, about 50%, about 60%, or about 70% less than a corresponding pressor effect observed following administration of 1,3-DMPA. In certain embodiments, pressor effect refers to one or more of the following effects: increased systolic blood pressure, increased diastolic blood pressure, increased heart rate, and increased rate pressure product (heart rate×systolic blood pressure).

These aspects of the present invention further relate to methods that achieve an effect on energy balance, CNS stimulation, mood, vigor, lipolysis, energy expenditure, and/or appetite in mammals to a greater extent relative to other methods using 1,3-DMPA, at least in part because a mammal can tolerate higher doses and/or longer durations of administration of 1,4-DMPA compared to the doses and/or durations that can be tolerated for 1,3-DMPA. These aspects of the present invention, therefore, relate to methods comprising administering 1,4-DMPA to humans to achieve an effect on CNS stimulation, mood, vigor, lipolysis, energy expenditure, and/or appetite, whereby the effect(s) achieved are greater than such effect(s) achieved by a method comprising administration of 1,3-DMPA. In addition or alternatively, the nature of the CNS stimulatory effect achieved by 1,4-DMPA is unexpectedly improved when compared to the effect achieved by 1,3-DMPA, in that the stimulant effect resulting from 1,4-DMPA administration is primarily characterized by an increase in focus and alertness, with less restlessness, anxiety, and/or other similar feeling.

Another aspect of the present invention relates to methods comprising administering 1,4-DMPA to affect energy balance, achieve CNS stimulation, reduce sense of fatigue, improve mood, increase vigor, increase lipolysis, increase energy expenditure, and/or reduce appetite, without significantly increasing vasoconstriction or raising blood pressure. The present invention also relates to methods comprising administering 1,4-DMPA to achieve a CNS stimulant effect, decreased fatigue, improved mood, increased vigor, increased lipolysis, increased energy expenditure, and/or reduced appetite, whereby any concomitant vasopressor effects are unexpectedly reduced when compared to the pressor effects resulting from a method comprising administering 1,3-DMPA.

Accordingly, certain aspects of the present invention relate to methods comprising administering an amount of 1,4-DMPA effective to affect energy balance, increase CNS stimulation, decrease sense of fatigue, improve mood, increase vigor, increase lipolysis, increase energy expenditure, and/or reduce appetite in humans, wherein the amount of 1,4-DMPA exhibits a 1,4-DMPA pressor effect that is less than a 1,3-DMPA pressor effect resulting from administering an amount of 1,3-DMPA that is substantially equivalent to the amount of 1,4-DMPA. In certain embodiments, the 1,4-DMPA pressor effect and the 1,3-DMPA pressor effect refer to an effect on systolic blood pressure, diastolic blood pressure, heart rate, and/or rate pressure product (heart rate×systolic blood pressure). In further embodiments, the 1,4-DMPA pressor effect is less than the 1,3-DMPA pressor effect by a factor of at least about 0.10. For example, in certain embodiments, the 1,4-DMPA pressor effect is less than the 1,3-DMPA pressor effect by a factor ranging from about 0.10 to about 0.75.

The present invention encompasses all 1,4-dimethylpentylamine compounds, including the base compound and any salts, esters, and any precursors or derivatives that yield the compound before or after oral, transdermal, intranasal, or other parenteral administration in mammals (e.g., in humans). Unless otherwise indicated, the terms 1,4-dimethylpentylamine and 1,4-DMPA as used herein encompass the racemic mixture of (R)-1,4-dimethylpentylamine and (S)-1,4-dimethylpentylamine, either enantiomer in its pure or substantially pure form (for example, (R)-1,4-DMPA substantially free from (S)-1,4-DMPA, or (S)-1,4-DMPA substantially free from (R)-1,4-DMPA), and the compound as a non-racemic or enantiomerically enriched form (i.e., a mixture having greater than 50% but less than 100% of either enantiomer, and less than 50% of the other enantiomer). In some embodiments of the invention, an enriched mixture of a given enantiomer contains no more than about 40%, 35%, 30%, 25%, 20%, 15%, 10%, 5%, 4%, 3%, 2%, or 1% of the other enantiomer. In particular embodiments of the present invention, the enriched 1,4-DMPA form contains mainly (R)-1,4-DMPA and no more than about 40%, 35%, 30%, 25%, 20%, 15%, 10%, 5%, 4%, 3%, 2%, or 1% of the (S)-1,4-DMPA enantiomer. In one embodiment, the enantiomer administered is (R)-1,4-DMPA in its pure or substantially pure form. In alternative embodiments, the enriched 1,4-DMPA form contains mainly (S)-1,4-DMPA and no more than about 40%, 35%, 30%, 25%, 20%, 15%, 10%, 5%, 4%, 3%, 2%, or 1% of the (R)-1,4-DMPA enantiomer. Furthermore, in particular embodiments wherein the compositions and methods result in an improved activity profile or a reduced pressor effect, the 1,4-DMPA is enantiomerically enriched (R)-1,4-DMPA. In a further embodiment, the 1,4-DMPA is pure or substantially pure (R)-1,4-DMPA.

Stereoisomeric purity of compounds may be established by conventional analytical methods well known to those of skill in the art. For example, use of chiral NMR shift reagents, gas chromatographic analysis using chiral columns, high pressure liquid chromatographic analysis using chiral columns, polarimetry, isotopic dilution, calorimetry, enzymatic methods, capillary electrophoresis on chiral gels, formation of diastereomeric derivatives through reaction with chiral reagents and conventional analysis via known analytical methods may be used to establish the stereochemical purity of a specific stereoisomer. Alternatively, synthesis using starting materials of known stereochemical enrichment may be used to establish the stereochemical purity of the compounds described herein. See, e.g., Example 1. Other analytical methods for demonstrating stereochemical homogeneity are known in the field. See, e.g., Organic Syntheses, Coll., 49: 93 (1969) and 5: 932 (1973); Theilacker and Winkler, Chemische Berichte, 87: 690-91 (1954); Ferreira et al., Rational approach to the selection of conditions for diastereomeric resolution of chiral amines by diacid resolving agents, Tetr. Asymmetry 17: 1337-1348 (2006); and Li et al. (2012), which are all incorporated herein by reference.

An additional aspect of the present invention, therefore, relates to uses and methods comprising administering non-racemic (i.e., optically active, or where the ratio of enantiomers is not 1:1) 1,4-DMPA or an enantiomer of 1,4-DMPA to stimulate CNS, decrease sense of fatigue, improve mood, increase vigor, increase lipolysis, increase energy expenditure, and/or decrease appetite. Methods comprising administration of non-racemic 1,4-DMPA present another advantage of the present invention. Accordingly, certain embodiments of the present invention relate to methods comprising administering an enriched 1,4-DMPA form to humans, where the enriched forms contains mainly (R)-1,4-DMPA and no more than about 40%, 35%, 30%, 25%, 20%, 15%, 10%, 5%, 4%, 3%, 2%, or 1% of the (S)-1,4-DMPA enantiomer. In one embodiment, the method comprises administration of pure or substantially pure (R)-1,4-DMPA. In alternative embodiments, the enriched 1,4-DMPA form contains mainly (S)-1,4-DMPA and no more than about 40%, 35%, 30%, 25%, 20%, 15%, 10%, 5%, 4%, 3%, 2%, or 1% of the (R)-1,4-DMPA enantiomer.

The terms 1,4-dimethylpentylamine and 1,4-DMPA, and references to the compound's enantiomers, are meant to encompass all salts of the compound. A salt of 1,4-DMPA refers to the base compound and derivatives of 1,4-DMPA that are modified by making acid salts thereof. Such salts include, but are not limited to, mineral or organic acid salts, and the conventional non-toxic salts or the quaternary ammonium salts, for example, from non-toxic inorganic or organic acids. Such conventional non-toxic salts include those derived from inorganic acids such as hydrochloric acid, hydrobromic acid, sulfuric acid, sulfamic acid, phosphoric acid, and nitric acid; and the salts prepared from organic acids such as formic acid, acetic acid, propionic acid, succinic acid, glycolic acid, stearic acid, lactic acid, malic acid, tartaric acid, citric acid, ascorbic acid, pamoic acid, maleic acid, hydroxymaleic acid, phenylacetic acid, glutamic acid, benzoic acid, salicylic acid, sulfanilic acid, 2-acetoxybenzoic acid, fumaric acid, toluenesulfonic acid, methanesulfonic acid, ethane disulfonic acid, benzenesulfonic acid, oxalic acid, isethionic acid, acidic amino acids (such as aspartic acid and glutamic acid), and the like. In some embodiments, 1,4-DMPA salts of the present invention include, for example, acetate, hydrochloride, ethyl ester, tartrate, malate, lactate, sulfate, maleate, fumarate, citrate, oxaloacetate, pyruvate, etc.

Salts of the present invention can be synthesized by reacting the free base of 1,4-DMPA with a stoichiometric amount of the appropriate acid in water or in an organic solvent, or in a mixture of the two—generally, nonaqueous media such as ether, ethyl acetate, ethanol, isopropanol, or acetonitrile may be used. Lists of exemplary salts are found in texts such as Remington's Pharmaceutical Sciences, 18th ed., Mack Publishing Company, Easton, Pa., 1990, which is incorporated herein by reference.

In certain aspects of the present invention, the 1,4-dimethylpentylamine compound is administered to an individual in an amount sufficient for the individual to experience CNS stimulation, improved mood, and/or appetite suppression. In certain embodiments of the present invention, 1,4-dimethylpentylamine is administered to a human in an amount effective or sufficient to stimulate CNS, decrease the sense of fatigue, improve mood, increase vigor, increase lipolysis, increase energy expenditure, and/or reduce appetite. In certain embodiments, the compound is administered in an amount of approximately 1 mg to 500 mg. In further embodiments, the compound is administered in an amount of about 1 mg, 5 mg, 10 mg, 20 mg, 25 mg, 30 mg, 35 mg, 40 mg, 50 mg, 75 mg, 100 mg, 125 mg, 150 mg, 175 mg, 200 mg, 225 mg, 250 mg, and/or 300 mg (in absolute amount, or as milligram per kilogram). In some embodiments, the amount of 1,4-DMPA administered is an amount per kilogram (kg). In certain aspects of such embodiments, the amount ranges from about 0.25 mg/kg to about 5 mg/kg. In further embodiments, the amount of 1,4-DMPA is about 0.5 mg/kg, 0.75 mg/kg, 1 mg/kg, 1.5 mg/kg, or 2 mg/kg.

Each amount of 1,4-DMPA may be administered as a single daily dose, or alternatively may be divided into multiple doses to be taken throughout the day (e.g., in two administrations, morning and afternoon, in three administrations, etc.). A given amount or daily dose may depend on a variety of factors, including, for example, the individual's size, sex, medical history, health status, and/or other agents or medications taken. In addition, a given amount or daily dose of 1,4-DMPA may depend on whether the compound is administered with other CNS stimulants, and/or whether it is administered as a racemate or an enantiomerically enriched or enantiomerically pure form.

The compound 1,4-DMPA can also be combined with another compound or component as part of a formulation or supplement. Accordingly, the present invention relates to compositions comprising 1,4-DMPA in combination with one or more other substances, agents, components, compounds, or dietary ingredients. Similarly, as used throughout the description, methods comprising administering 1,4-DMPA (or analogous methods referring to 1,3-DMPA administration) encompass combination treatments wherein the compound is administered with one or more other substances, compounds, agents, supplements, dietary ingredients, etc. Such other substances, compounds, agents, supplements, dietary ingredients, etc., include but are not limited to amino acids, minerals, vitamins, and more generally antioxidants, nutrients, and plant extracts or other naturally occurring compounds. These substances include, without limitation, caffeine, theophylline, paraxanthine, phenethylamine, arginine α-ketoglutarate, rauwolscine, yohimbine, tyrosine, n-acetyl-1-tyrosine, creatine (in any form, including, e.g., creatine monohydrate and creatine ethyl ester), β-alanine, caffeic acid, higenamine (or norcoclaurine), citicoline, and plant extracts. Plant extracts in turn include but are not limited to bauhinia purpurea L., bacopa monnieri, schisandra chinensis, hemerocallis fulva, yohimbe (pausinystalia johimbe), cirsium oligophyllum, and other naturally occurring compounds. More generally, such other substances include, without limitation, antioxidants, vitamins (e.g., nicotinamide, riboflavin, pantothenic acid, and vitamin-like substances such as coenzyme Q₁₀), minerals, and amino acids (e.g., propionyl L-carnitine).

Accordingly, formulations or combinations comprising 1,4-DMPA include but are not limited to the following: a composition comprising 1,4-DMPA and one or more other naturally occurring substances (including, e.g., a plant extract); a composition comprising 1,4-DMPA and caffeine; a composition comprising 1,4-DMPA and one or more other naturally occurring substances selected from the group consisting of caffeine, citicoline, bauhinia purpurea L. extract, hemerocallis fulva (flower) extract, yohimbe (pausinystalia johimbe) (bark) extract, and higenamine (or norcoclaurine). The formulations and combinations of the invention therefore include but are not limited to a composition comprising 1,4-DMPA, caffeine, and one or more other naturally occurring substances. In further embodiments, such one or more naturally occurring substances is selected from the group consisting of bauhinia purpurea L. extract, hemerocallis fulva (flower) extract, and yohimbe (pausinystalia johimbe) (bark) extract and higenamine or norcoclaurine. As used herein, a naturally occurring substance includes compounds and substances isolated or extracted from plant material, as well as compounds and substances that occur naturally but that are made synthetically.

Compositions comprising 1,4-DMPA, including combinations comprising 1,4-DMPA, may be formulated for oral administration. Accordingly, in certain embodiments of the present invention, 1,4-DMPA is formulated as an oral dosage form, such as, for example, a tablet, capsule, gel cap, powder, gel, solution or other orally ingestible form. In the above and other combinations, administration may involve the administration of a single composition that in turn comprises multiple components or substances, including 1,4-DMPA. Such an example would be a dietary supplement, formulated as an oral dosage form (e.g., a tablet, capsule, gel, powder, or solution), that comprises several dietary ingredients and optionally other ingredients, including, for example, one or more excipients. In addition or alternatively, methods comprising administering 1,4-DMPA (or 1,3-DMPA) may involve concurrent administration of multiple, separate oral dosage forms, or any other combination of administrations and dosage routes.

Accordingly, the formulations and compositions of the present invention may optionally include one or more other ingredients such as, for example, one or more excipients. Such other ingredients include but are not limited to binders (e.g., gelatin, saccharides, polymers, cellulose, starch, etc.), disintegrants (e.g., crosslinked polymers, modified starch, colloidal silicon dioxide, etc.), fillers (e.g., vegetable oils, lactose, sucrose, glucose, mannitol, sorbitol, magnesium stearate, etc.), lubricants and glidants (e.g., talc, magnesium stearate, silicon dioxide, etc.), stabilizers (e.g., modified food starch, gelatin, etc.), as well as flavors, colorings, and coating agents. Thus, according to certain embodiments, the present invention relates to compositions comprising 1,4-DMPA, caffeine, and one or more other naturally occurring substances, wherein the naturally occurring substance is selected from the group consisting of bauhinia purpurea L. extract, hemerocallis fulva (flower) extract, yohimbe (pausinystalia johimbe (bark) extract, citicoline, and higenamine or norcoclaurine, and wherein the composition further comprises one or more excipients. In specific embodiments, the one or more excipients is selected from the group consisting of gelatin, modified starch or maltodextrin, vegetable or magnesium stearate, silicon dioxide, and artificial or natural food colorings.

Certain embodiments of the present invention further relate to combinations and formulations comprising 1,4-DMPA and one or more dietary and/or other ingredients in specific proportions. For example, an amount of 1,4-DMPA in a given composition may range from about 5% to about 20% of the composition by weight, and such compositions may include one or more dietary and/or other ingredients, including, for example, caffeine, one or more other naturally occurring substances, and/or one or more excipients. Possible proportions (or percentages by weight) for these dietary and other ingredients include, for example, about 30% to about 70% caffeine; about 20% to about 50% of one or more other naturally occurring substance(s); and about 5% to about 15% excipient(s). A more specific example under this embodiment may include the following ranges or proportions: 1,4-DMPA (about 1% to about 15%); caffeine (about 35% to about 75%); one or more plant extracts or other naturally occurring substances (about 10% to about 75%); and one or more excipients (about 15% to about 20%) (percentages correspond to % by weight). In certain of the above embodiments, the one or more plant extracts or other naturally occurring substances is selected from the group consisting of bauhinia purpurea L. extract, hemerocallis fulva (flower) extract, yohimbe (pausinystalia johimbe) (bark) extract, and higenamine or norcoclaurine. Therefore, in certain embodiments, the composition comprises 1,4-DMPA, caffeine, bauhinia purpurea L. extract, hemerocallis fulva (flower) extract, yohimbe (pausinystalia johimbe) (bark) extract, and higenamine or norcoclaurine, and in more specific embodiments the composition comprises 1,4-DMPA (e.g., at about 1% to about 15%); caffeine (e.g., at about 35% to about 45%); bauhinia purpurea L. extract (e.g., at about 15% to about 25%); hemerocallis fulva extract (e.g., at about 0.5% to about 5%); yohimbe (pausinystalia johimbe) (bark) extract (e.g., at about 0.5% to about 5%); and higenamine or norcoclaurine (e.g., at about 5% to about 15%). The compositions of the present invention may further comprise one or more excipients selected from the group consisting of maltodextrin, magnesium stearate, and silicon dioxide. In still further embodiments, the compositions comprise maltodextrin (e.g., at about 1% to about 5%); magnesium stearate (e.g., at about 1% to about 10%); and/or silicon dioxide (e.g., at about 1% to about 10%). While the above embodiments describe the amount of 1,4-DMPA in terms of percentage of the composition by weight, these percentages may correspond to the dosage and milligram amounts described elsewhere herein. For example, a composition comprising 1,4-DMPA in an amount of about 30 mg may comprise 1,4-DMPA in an amount corresponding to about 5% to about 15% of the composition by weight.

Further, while the embodiments described herein primarily concern oral administration of 1,4-DMPA or of any combination or composition comprising 1,4-DMPA, the methods and uses of the present invention encompass other routes of administration, including, without limitation, transdermal, intranasal, and other parenteral route.

The administration of 1,4-DMPA is ultimately able to affect energy balance, and after repeated or extended administrations, affect body composition. Such outcomes may involve several effects or mechanisms, including a CNS stimulant effect, which in turn can increase strength output while also providing the user with increased alertness and a lessened sense of fatigue. Administration of 1,4-DMPA can also improve mood and vigor. One or more of these effects allows the user to train for extended periods of time at a higher intensity, thereby facilitating a gain in skeletal muscle strength and mass over time. In addition, 1,4-DMPA administration may decrease fat mass by increasing lipolysis and energy expenditure; individuals ingesting 1,4-DMPA report improved exercise performance and a reduction in fat mass. 1,4-DMPA may also decrease fat mass by suppressing appetite and decreasing energy input. Each mechanism or effect, alone or in combination, allows for a shift in body composition where the end result is an increase in skeletal muscle mass and strength and/or a decrease in fat mass. Such a shift in body composition is beneficial to individuals who face health risks associated with obesity. Each mechanism or effect, alone or in combination, may also improve fitness. Administration of 1,4-DMPA can additionally improve a user's mood and sense of well-being. Moreover, the unexpected and advantageous activity profile of 1,4-DMPA compared to 1,3-DMPA makes 1,4-DMPA a uniquely suitable dietary supplement for individuals who desire weight loss and/or improved fitness and well-being.

### EXAMPLES

The following examples are for illustration only. Persons skilled in the art will appreciate that modifications, to both materials and methods, are within the scope of the invention.

### Example 1

### Chemical Synthesis of Racemic 1,4-DMPA and Each of its Enantiomers

The compound 1,4-DMPA, which occurs naturally in geranium, can be made synthetically. The synthesis scheme below provides an exemplary synthesis scheme, for illustration purposes only, for both racemic and enantiomeric forms of 1,4-dimethylpentylamine. The scheme provides only one example of different salts that could be made for both (R)-1,4-dimethylpentylamine and (S)-1,4-dimethylpentylamine. For example, in this particular scheme, the tartaric acid salt or HCl salt of the compound is made. The example shows a method for synthesizing racemic 1,4-dimethylpentylamine, followed by the production of an enantiomerically pure version of both the R and S enantiomers of 1,4-dimethylpentylamine, by using tartaric acid as a resolving agent.

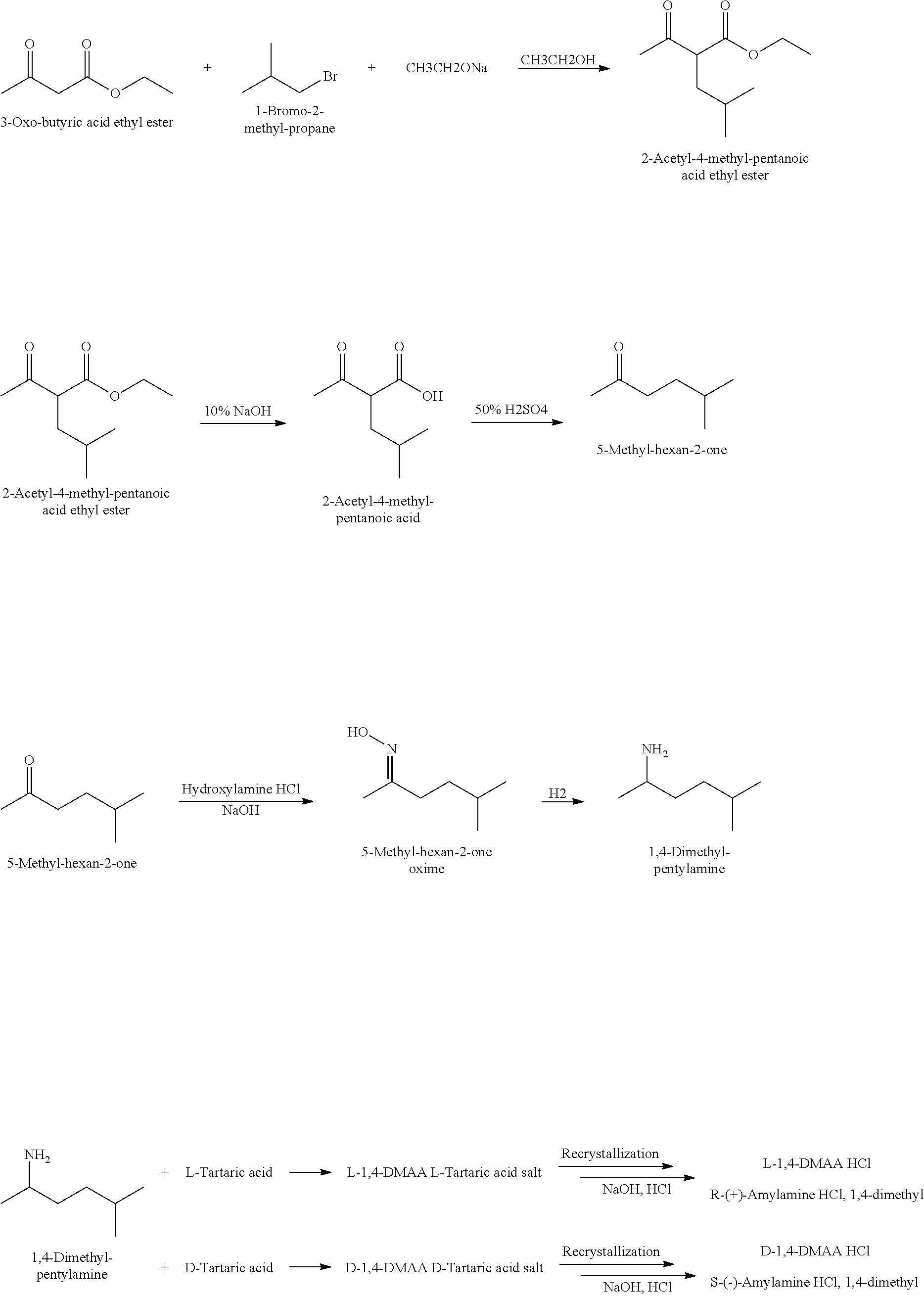

### Example 2

### Acute Toxicity and Tolerance in Mammals

The maximum tolerated dose (MTD) of orally administered 1,3-DMPA and 1,4-DMPA was determined in New Zealand white rabbits and Wistar rats.

Determination of MTD of orally-administered 1,3-DMPA in New Zealand white rabbits: Twenty-four rabbits (twelve male, twelve female) were quarantined for at least seven days and then were randomly divided into four groups with six animals (3 male and 3 female) in each group. The groups were treated as follows: Group I (vehicle control—water), Group II (50 mg/kg), Group III (150 mg/kg), and Group IV (300 mg/kg). Animals were observed daily for fourteen days following administration. Each animal's body weight, food intake, mortality, and natural orifices were monitored. Clinical observations included skin condition, gait, movement, neurological disorders, eye condition, feces, convulsions, tremors, activity rate, restlessness, grooming, sleep, aggressiveness, salivation, diarrhea, respiration, appetite, thirst and urine conditions. Other observations included fur condition, mucous membranes, presence or absence of secretions and excretions and autonomic activity, lacrimation, piloerection, pupil size, posture, arched back, distended abdomen, fur, mucous membrane, presence or absence of secretions, tail elevation, motor activity, urination and defecation, and response to handling as well as the presence of clonic or tonic movements, repetitive circling, bizarre behavior, self-mutilation and walking backwards. At the conclusion of the fourteen day monitoring period, gross pathological examination was carried out on all animals. Heart, lung, liver, kidneys, spleen, stomach, large intestine, small intestine, brain and skin were examined for any macroscopic lesions.

The mean body weights of animals in all four groups indicated a consistent increase during the study period. The mean food intake was normal in all groups, though there was an observed initial decrease in food intake in the treatment groups during the first observations following treatment. Animals receiving 50 mg/kg did not exhibit any behavioral aberrations. However, animals treated with 300 mg/kg exhibited nasal discharge, salivation, tremors, convulsions and tachycardia, and four animals in this group died within four hours after dosing. A few animals treated with 150 mg/kg exhibited tremors during hours 1-6 after administration. Gross pathological observations indicated no changes in animals treated with vehicle, 50 mg/kg, or 150 mg/kg. Animals that were reported dead after receiving 300 mg/kg showed reddish discoloration in the lungs, multiple watery cyst on the right median lobe of the liver and focal white patches; the spleen showed focal whitish deposit on the surface, and the stomach showed glandular mucosa with focal hyperaemia during gross necropsy. The MTD of a single oral dose of 1,3-DMPA was determined to be between 150 mg/kg and 300 mg/kg.

Determination of MTD of orally-administered 1,4-DMPA in New Zealand white rabbits: Thirty rabbits (fifteen male, fifteen female) were quarantined for at least seven days and then were randomly divided into five groups with six animals (3 male and 3 female) in each group. The groups were treated as follows: Group I (vehicle control—water), Group II (50 mg/kg), Group III (125 mg/kg), Group IV (250 mg/kg), and Group V (350 mg/kg). Animals were observed daily for fourteen days following administration. Each animal's body weight, food intake, mortality, and natural orifices were monitored. As above, clinical observations included observation of natural orifices for any abnormal secretions and monitoring for the presence or absence of secretions and excretions, monitoring of mucous membranes, fur and skin condition, mortality, gait, posture, arched back, distended abdomen, movement and motor activity, neurological disorders, eye condition and pupil size, feces, convulsions, tremors, tail elevation, activity rate, restlessness, grooming, sleep, aggressiveness, salivation, diarrhea, respiration, appetite, thirst and urine conditions, autonomic activity, lacrimation, piloerection, response to handling, as well as the presence of clonic or tonic movements, repetitive circling, bizarre behavior, self-mutilation and walking backwards. At the conclusion of the fourteen day monitoring period, gross pathological examination was carried out on all animals. Heart, lung, liver, kidneys, spleen, stomach, large intestine, small intestine, brain and skin were examined for any macroscopic lesions.

Mean body weights of animals in all treatment groups except Group V showed a consistent increase during the fourteen day period when compared to the vehicle control group. Animals in Group V exhibited variation in body weight during the study period. Mean food intake was reduced in all treatment groups compared to control during the first 48 hours post treatment, though food intake then increased gradually until Day 14.

All animals treated with 250 mg/kg and 350 mg/kg showed tremors and tachycardia. Only one mortality was observed; an animal in Group 5 died within 36 hours following administration of 350 mg/kg of test agent. No mortalities in other treatment groups were observed. No gross pathological changes were observed in the treated groups, except that the animal that died after 36 hours post dosing with 350 mg/kg of test article showed presence of dark reddish discoloration of the lung suggesting congestion, slight reddish discoloration of the trachea, and mild petechial hemorrhages in the liver. The MTD of a single oral dose of 1,4-DMPA was determined to be between 250 mg/kg and 350 mg/kg.

Determination of MTD of orally-administered 1,3-DMPA in Wistar rats: The same general methods and procedures were followed as described above. This study involved forty animals randomly divided into four groups of ten animals (five male, five female) in each group. The groups were treated as follows: Group I (vehicle control—water), Group II (50 mg/kg), Group III (125 mg/kg), and Group IV (250 mg/kg). All treatment groups showed a consistent increase in the mean body weight. Mean food intake was normal in all animals treated with 50 and 125 mg/kg; animals treated with 250 mg/kg appeared to show decreased food intake on Day 3, which gradually increased thereafter. Animals in all treatment groups showed piloerection, tail elevation, nasal discharge and hyperactivity, while animals dosed with 250 mg/kg also exhibited tremors. One preterminal mortality was reported from Group IV (250 mg/kg) within 26 hours of dosing; no mortalities occurred in the lower dose groups. Necropsy analysis indicated hyperemia in the stomach glandular mucosa; congestion of lungs, liver and adrenals; the presence of blood clots in the cranial cavity; and ballooning of the small intestine with reddish yellow fluid. The MTD of a single oral dose of 1,3-DMPA was determined to be between 125 mg/kg and 250 mg/kg.

Determination of MTD of orally-administered 1,4-DMPA in Wistar rats: The same general methods and procedures were followed as described above. This study involved forty animals randomly divided into four groups of ten animals (five male, five female) in each group. The groups were treated as follows: Group I (vehicle control—water), Group II (75 mg/kg), Group III (150 mg/kg), and Group IV (300 mg/kg). The treatment groups appeared to consume less feed during the first 48 hours post administration, though mean body weights of treated animals consistently increased during the study period when compared to the control group. All treated animals showed piloerection, tail elevation, nasal discharge, tachycardia and hyperactivity. Tremors and convulsions were also observed in the groups treated with 150 mg/kg and 300 mg/kg. No behavioral abnormalities were observed in control animals. Four mortalities were recorded within 4.5 hours of drug administration for animals treated with 300 mg/kg of the agent. No mortalities were reported from other treatment groups. Gross pathological changes were not observed in the treated groups during necropsy. Examination of the four animals that died 4.5 hours post dosing with 300 mg/kg revealed presence of right median lobe consolidation and red foci on lungs, mild reddish discoloration of adrenals and spleen, mild enlargement of the spleen and glandular mucosa of the stomach showing hyperemia. The MTD of a single oral dose of 1,4-DMPA was determined to be between 150 mg/kg and 300 mg/kg in Wistar rats.

The single-dose rat and rabbit studies generally show that 1,4-DMPA is less toxic and better tolerated than 1,3-DMPA:

| | Rabbit | | | |
|---|---|---|---|---|
| | MTD | | Rat | |
| Compound | (mg/kg) | LD₅₀ (mg/kg) | MTD (mg/kg) | LD₅₀ (mg/kg) |
| 1,3-DMAA | 150-300 | 324.339 | 125-250 | 481.948 |
| 1,4-DMAA | 250-350 | 27419.7 | 150-300 | 465.161 |

### Example 3

### Comparative Effects of 1,3-DMPA and 1,4-DMPA Compounds in Humans

The compounds 1,3-DMPA, racemic 1,4-DMPA, (R)-1,4-DMPA, and (S)-1,4-DMPA were administered to human(s). A non-smoking male of normal weight ingested 40 mg 1,3-DMPA as part of a dietary supplement (dietary ingredients: arginine α-ketoglutarate, creatine monohydrate, β-alanine, caffeine, 1,3-dimethylpentylamine HCL, schisandra cinensis (berry) extract (standardized for schizandrol A)); powder form), self-administered daily for at least seven days. This individual experienced decreased appetite, improved mood, and improved physical performance during exercise and strength training activities. In addition, this individual experienced CNS stimulation, including feelings of restlessness and jitteriness. The individual also experienced increased heart rate. To compare the effects of 1,3-DMPA to the effects of 1,4-DMPA, this individual later ingested 1,4-DMPA (racemic) for at least seven days at a dose of 60 mg per day, combined with 250 mg caffeine. The individual experienced about the same level of CNS stimulation, though with a noticeable difference in the nature of the stimulatory effect. The stimulatory effect was characterized by increased focus and alertness and reduced fatigue; and when compared to the prior ingestion of 1,3-DMPA, the effect was also characterized by noticeably reduced feelings of jitteriness or anxiousness, and a reduced effect on heart rate. The individual also felt decreased appetite, as well as improved mood and vigor and improved physical performance during the time of administration. 1,4-DMPA was also given to other individuals, who experienced similar positive effects (increased focus and alertness, decreased fatigue, decreased appetite, improved mood, and improved physical performance).

To compare the effects of (R)-1,4-DMPA, and (S)-1,4-DMPA, the male individual described above ingested each enantiomer separately. Starting dose was ˜20 mg per day, which was increased to 30 mg per day if treatment was continued. Doses were combined with 250 mg caffeine as described above. For (R)-1,4-DMPA, the starting dose of 20 mg per day produced CNS stimulant effect but with little or no jitteriness or pressor effect. The dose was increased to 30 mg per day; the total duration of treatment was at least three weeks. During this time, the individual experienced CNS stimulation, including feelings of alertness, focus, and reduced fatigue, as well as decreased appetite, improved mood, and improved physical performance. These effects were not associated with a noticeable increase in heart rate, jitteriness, nervousness, or anxiety. Ingestion of (S)-1,4-DMPA (25-30 mg per day) with caffeine produced different effects. In comparison to (R)-1,4-DMPA, ingestion of (S)-1,4-DMPA resulted in increased heart rate and restlessness, and lessened alertness and focus. The individual ceased self-administering (S)-1,4-DMPA after several days of experiencing the latter effects.

### Example 4

### Vasopressor Effects, Lipolysis, CNS Stimulation, Mood/Vigor, Thermogenesis, Appetite Suppression, Strength Output, and Body Composition in Humans

This prophetic study involves a comparison of single-dose administrations of 1,4-DMPA and 1,3-DMPA to humans in order to quantify the acute effect of each compound on vasoconstriction, lipolysis, CNS stimulation, mood, thermogenesis, and appetite suppression. In a double-blinded cross-over test, six to eight healthy, non-smoking subjects of normal weight are randomly assigned to receive 1,3-DMPA or 1,4,DMPA. Separate test sessions are conducted, such that all of the subjects receive each of the different treatments but on different days, thereby generating multiple data points for each treatment group. Doses/treatments will be separated by at least three days. The subjects are instructed to refrain from exercise during the 24 hours prior to the morning of administration, and no caffeine or stimulatory dietary supplements or performance drinks should be used during the 24 hours before and after dosing.

On the morning of administration or ingestion, and following an overnight fast, the subjects arrive to a testing room, are weighed, and then are asked to sit quietly for ten minutes. Following this quiet rest period, each subject's heart rate (HR), systolic blood pressure (SBP), and diastolic blood pressure (DBP) are measured and recorded as a baseline. Each subject is asked to wait ten additional minutes, after which heart rate and blood pressure are measured a second time for the baseline. Following these measurements and before administration, a blood sample from each subject is collected. Each subject is then given a test compound, which is either 1,4-DMPA or 1,3-DMPA, each in an amount or dose of 80 mg. Other doses or amounts (e.g., 60, 70, or 90 mg) can alternatively or additionally be tested. Each subject ingests his test compound and is instructed to sit quietly in the test room. Heart rate, systolic blood pressure, and diastolic blood pressure are then measured and recorded at times 30, 60, 90, and 120 minutes post-ingestion, and optionally again at 180 minutes. Blood samples are also collected at time 60 minutes, after heart rate and blood pressure data are measured at that time point. No food intake is allowed during the study period; each subject is allowed a total of eight ounces of water to be consumed ad libitum.

CNS stimulation, mood, vigor, thermogenesis, and appetite are monitored from the time right before ingestion until two or optionally three hours post-ingestion. Each subject is asked to rate his mood as well as sense of fatigue, drowsiness, and tiredness, level of focus and alertness, energy level, level of twitchiness and restlessness, ability to sit still, and level of anxiety and nervousness. Each subject is also asked to rate his sense of hunger, sense of fullness, desire to eat, and/or the amount of food he thinks could be consumed at that moment. These outcomes can be measured and compared using the visual analog scale (VAS). See, e.g., Kaplan et al., Dose-dependent pharmacokinetic and psychomotor effects of caffeine in humans, J. Clin. Pharmacol. 37: 693-703 (1997), which is incorporated herein by reference, and which describes different visual analog scale items (such as energetic/fatigued; thinking slowed down/thinking speeded up; calm/anxious; normal/spacey; relaxed/excited; at ease/nervous) and the statistical analysis employed to quantify these items. Accordingly, the subjects are asked to rate parameters on a visual analog scale (e.g., for mood, 0=extremely sad and 10=extremely happy; for hunger, 0=not at all hungry and 10=extremely hungry; etc.). Each subject is asked to rate these aspects immediately before ingestion, and at times 30, 60, 90, and 120 minutes, and optionally again at 180 minutes. For information on using visual analog scales as a measure of appetite, see Flint et al., Reproducibility of appetite scores, Int. J. Obesity 24: 38-48 (2000), which is incorporated herein by reference.

Thermogenesis can be measured using known methods, such as by using indirect calorimetry. See Johnston et al., Postprandial thermogenesis is increase 100% on a high-protein, low-fat diet versus a high-carbohydrate, low-fat diet in healthy, young women, J. Am. College Nut. 21: 55-61 (2002); Acheson et al., Metabolic effects of caffeine in humans: lipid oxidation or futile cycling?, Am. J. Clin. Nutr. 79: 40-6 (2004), which are incorporated herein by reference. In addition, thermogenesis can be assessed by measuring body temperature (accounting for natural circadian changes in body temperature), as well as by each subject's self-assessment of a thermogenic effect, including by a visual analog scale (e.g., 0=normal/no increase in temperature; 10=very hot). For example, just prior to temperature measurement, each subject may record his sense of feeling cool or hot using VAS.

Pressor effect: Heart rate and blood pressure data (including rate pressure product) are analyzed using a 2 (condition)×5 (time) analysis of variance (ANOVA). Analysis of variance is also performed to assess change from baseline (pre-ingestion) for HR and blood pressure. A correlation analysis (for each test condition independently) on sex, body weight, and the percent change in SBP and DBP at 60 minutes post-ingestion is also performed. Statistical significance is set at p≦0.05.

Lipolysis: Each blood sample is collected from the subject's forearm and is processed in a refrigerated centrifuge (4° C. for 15 minutes at 1500-2000 g). Plasma samples are rapidly frozen in liquid nitrogen and then stored at −20° C. until analyzed for free fatty acid content. The concentration of free fatty acids in each sample is determined by using the Free Fatty Acid Quantification Kit (K612-100) according to the manufacturer's instructions (BioVision). Data are analyzed using a 2 (condition)×2 (time) analysis of variance (ANOVA), and statistical significance is set at p≦0.05. Analysis is also performed to measure changes from baseline (pre-ingestion).

CNS stimulation, mood, thermogenesis, and appetite suppression: Each subject's rating on the visual analog scale is converted to its number value; see Greenblatt et al., Sensitivity to triazolam in the elderly, N. Eng. J. Med. 324: 1691-1698 (1991) and Flint et al. (2000). Mixed or factorial analysis of variance (ANOVA) is performed. The data are analyzed by a 2 (condition)×2 (time) ANOVA, with statistical significance set at p 0.05. Analysis is also performed to measure changes from baseline.

Strength output and dynamic exercise performance: The protocol described above is modified to allow an assessment of the effect of 1,4-DMPA on strength output. In this study, each subject receives a test composition (either 80 mg 1,4-DMPA or placebo) for ingestion. Each subject performs a strength output test, both immediately before ingestion and at 40 minutes post-ingestion. The data are analyzed by a 2 (condition)×2 (time) analysis of variance (ANOVA), with statistical significance set at P 0.05.

To measure strength output, each subject first performs a one repetition maximum (1RM) test for the chest press (e.g., using Hammer Strength™ plate-loaded machines, following guidelines from the National Strength and Conditioning Association). This test is performed the day before administration to determine each subject's 1RM. After determination of the 1RMs, the subjects then practice the bench press throw (e.g., using a ProSpot® device; ProSpot Fitness, Norcross, Ga.).

To measure power and local muscular endurance, each subject performs a bench press throw on a device such as a ProSpot® or similar device. The device measures a maximum-effort throw where the bar is stopped at its highest vertical position. Following a warm-up of ˜10% of the subject's predetermined 1RM, each subject performs three maximum throws using 30% of the chest press 1RM, with ninety seconds of rest in between each throw. The best attempt (or highest power) of the three throws is recorded for data analysis. See, e.g., Falvo et al., Efficacy of prior eccentric exercise in attenuating impaired exercise performance after muscle injury in resistance trained men, J. Strength Conditioning Res. 21: 1053-1060 (2007), which is incorporated by reference. Kinetic and kinematic data is acquired through the combination of a floor scale (e.g., Roughdeck, Rice Lake Weighing Systems, Rice Lake, Wis.) and a linear velocity transducer (e.g., VP510, Unimeasure, Corvallis, Oreg.) attached to the barbell. Measurements of force and velocity are measured directly by the modified floor scale and linear transducer, respectively. Data are sampled at 1000 Hz and channeled through a 12-bit analog-to-digital converter (e.g., DAS1200Jr; Measurement Computing, Middleboro, Mass.). Data are smoothed using a 4th-order recursive Butterworth digital filter, and power is calculated as the product of force and velocity within the acquisition software (e.g., DataPac 5). After the bench press throws, and to measure upper-body local muscular endurance, each subject performs a maximal number of chest press repetitions to failure with 50% of the previously determined 1RM.

Body composition: The effects of prolonged or repeat 1,4-DMPA administrations on body composition can be measured by assessing each subject's body mass index (including percentage of fat mass and percentage of muscle mass). See, e.g., Jackson, A. S., & Pollock, M. L., Practical assessment of body composition, Physician and Sportsmedicine, 13: 76-90 (1985), which is incorporated herein by reference. Accordingly, the above protocol can be modified to allow for daily administrations of 1,4-DMPA over the course of one to four weeks. Each subject's body mass index is determined on the first day of administration (as a baseline) and again at the end of the study period, and optionally at other time points during the study period. Data are analyzed to quantify the effect of administration (control and 1,4-DMPA) on the percentage of muscle mass and fat mass over time.

Each of the methods described above is performed for test compounds (S)-1,4-DMPA and (R)-1,4-DMPA, and the effects of 1,3-DMPA are compared to (S)-1,4-DMPA and (R)-1,4-DMPA. Accordingly, in one study, subjects receive either 1,3-DMPA or (S)-1,4-DMPA under the protocols and steps described above. In the other study, subjects receive either 1,3-DMPA or (R)-1,4-DMPA under the protocols and steps described above. Statistical analysis such as ANOVA is performed to compare the test compounds to each other and to compare the effect of each compound to baseline.

The invention claimed is:

1. A composition comprising 1,4-dimethylpentylamine and one or more substances selected from the group consisting of caffeine, arginine α-ketoglutarate, rauwolscine, higenamine, yohimbine, creatine, β-alanine, bauhinia purpurea L. extract, bacopa monnieri extract, schisandra chinensis extract, hemerocallis fulva extract, yohimbe (pausinystalia johimbe) extract, and cirsium oligophyllum extract.

2. The composition of claim 1, wherein the 1,4-dimethylpentylamine is selected from the group consisting of
(R)-1,4-dimethylpentylamine;
(S)-1,4-dimethylpentylamine;
a racemic mixture of (R)-1,4-dimethylpentylamine and (S)-1,4-dimethylpentylamine;
a mixture of (R)-1,4-dimethylpentylamine and (S)-1,4-dimethylpentylamine, wherein the mixture is enriched for (R)-1,4-dimethylpentylamine;
and a mixture of (R)-1,4-dimethylpentylamine and (S)-1,4-dimethylpentylamine, wherein the mixture is enriched for (S)-1,4-dimethylpentylamine.

3. The composition of claim 2, wherein the 1,4-dimethylpentylamine is (R)-1,4-dimethylpentylamine.

4. The composition of claim 1, wherein the 1,4-dimethylpentylamine is selected from the group consisting of 1,4-dimethylpentylamine tartrate and 1,4-dimethylpentylamine HCl.

5. The composition of claim 1, wherein said composition is formulated as an oral dosage form.

6. The composition of claim 5, wherein the 1,4-dimethylpentylamine is present in an amount of ranging from about 5 mg to about 200 mg.

7. A method of administering a food or dietary supplement comprising: administering an amount of 1,4-dimethylpentylamine to a human, wherein the administering step results in one or more effects in the human selected from the group consisting of (a) increased stimulation of the central nervous system; (b) increased vigor; (c) improved mood; (d) increased focus; (e) decreased sense of fatigue; (f) increased lipolysis; (g) increased energy expenditure; and (h) suppressed appetite.

8. The method of claim 7, wherein the administering step is also effective to increase physical endurance of the human.

9. The method of claim 7, wherein the administering step is also effective to increase strength output of the human.

10. The method of claim 7, wherein said method results in increased energy output over a unit of time, wherein the unit of time ranges from about 4 hours to about 24 hours.

11. The method of claim 7, wherein said method results in decreased energy input over a unit of time, wherein the unit of time ranges from about 4 hours to about 24 hours.

12. The method of claim 7, wherein the 1,4-dimethylpentylamine is selected from the group consisting of
(R)-1,4-dimethylpentylamine;
(S)-1,4-dimethylpentylamine;
a racemic mixture of (R)-1,4-dimethylpentylamine and (S)-1,4-dimethylpentylamine;
a mixture of (R)-1,4-dimethylpentylamine and (S)-1,4-dimethylpentylamine, wherein the mixture is enriched for (R)-1,4-dimethylpentylamine;
and a mixture of (R)-1,4-dimethylpentylamine and (S)-1,4-dimethylpentylamine, wherein the mixture is enriched for (S)-1,4-dimethylpentylamine.

13. The method of claim 12, wherein the 1,4-dimethylpentylamine is (R)-1,4-dimethylpentylamine.

14. The method of claim 7, wherein the food or dietary supplement comprises one or more substances selected from the group consisting of caffeine, arginine α-ketoglutarate, rauwolscine, higenamine, yohimbine, creatine, β-alanine, bauhinia purpurea L. extract, bacopa monnieri extract, schisandra chinensis extract, hemerocallis fulva extract, yohimbe (pausinystalia johimbe) extract, and cirsium oligophyllum extract.

15. The method of claim 7, wherein the administering step is carried out twice per day.

16. The method of claim 7, wherein the administering step is repeated about daily over a time course ranging from about seven days to about six months.

17. The method of claim 16, wherein the amount of 1,4-dimethylpentylamine is a daily dose ranging from about 5 mg to about 200 mg.

18. The method of claim 16, wherein said method results in a decreased percentage of fat mass in the human.

19. The method of claim 16, wherein said method results in an increased percentage of muscle mass in the human.

20. The method of claim 7, wherein the amount of 1,4-dimethylpentylamine exhibits a 1,4-dimethylpentylamine pressor effect, wherein the 1,4-dimethylpentylamine pressor effect is less than a 1,3-dimethylpentylamine pressor effect resulting from administering an amount of 1,3-dimethylpentylamine that is substantially equivalent to the amount of 1,4-dimethylpentylamine.

21. The method of claim 20, wherein the 1,4-dimethylpentylamine pressor effect and the 1,3-dimethylpentylamine pressor effect are together selected from the group consisting of (a) an effect on heart rate, (b) an effect on systolic blood pressure, (c) an effect on diastolic blood pressure, and (d) an effect on rate pressure product.

22. The method of claim 21, wherein the 1,4-dimethylpentylamine pressor effect is about 10% to about 70% less than the 1,3-dimethylpentylamine pressor effect.

23. The method of claim 21, wherein the 1,4-dimethylpentylamine pressor effect and the 1,3-dimethylpentylamine pressor effect are both an effect on systolic blood pressure, and wherein the 1,4-dimethylpentylamine pressor effect is about 10% to about 70% less than the 1,3-dimethylpentylamine pressor effect.

24. The method of claim 20, wherein the 1,4-dimethylpentylamine is selected from the group consisting of
(R)-1,4-dimethylpentylamine;
(S)-1,4-dimethylpentylamine;
a racemic mixture of (R)-1,4-dimethylpentylamine and (S)-1,4-dimethylpentylamine;
a mixture of (R)-1,4-dimethylpentylamine and (S)-1,4-dimethylpentylamine, wherein the mixture is enriched for (R)-1,4-dimethylpentylamine;
and a mixture of (R)-1,4-dimethylpentylamine and (S)-1,4-dimethylpentylamine, wherein the mixture is enriched for (S)-1,4-dimethylpentylamine.

25. The method of claim 24, wherein the 1,4-dimethylpentylamine is (R)-1,4-dimethylpentylamine.
